(19) United States
(12) Patent Application Publication
(10) Pub. No.: US 2008/0067254 A1
(43) Pub. Date: Mar. 20, 2008

(54) Plastic Card for Special Member

(76) Inventor: Chanhee Lee, Gyeonggi (KR)

Correspondence Address: STEPTOE & JOHNSON LLP, 1330 CONNECTICUT AVENUE, N.W., WASHINGTON, DC, 20036, US

(21) Appl. No.: 11/813,974

(22) PCT Filed: Jan. 5, 2006
(86) PCT No.: PCT/KR06/00035

§ 371 Date: Sep. 4, 2007

(30) Foreign Application Priority Data
Jan. 19, 2005 (KR) 20-2005-001605

(51) Int. Cl. G06K 19/06

(52) U.S. Cl. 235/492

(57) ABSTRACT

Disclosed herein is a plastic card for a special member for providing a financial transaction function, which is decorated with noble metals and jewels and has a beautiful three-dimensional pattern formed on the surface thereof, thereby providing a user with refinement. The plastic card is manufactured by performing the steps of thermally bonding thin synthetic resin layer sheets to form a card sheet, die-cutting the card sheet into a number of rectangular finished cards, and attaching a magnetic tape for recording information on the finished cards or having an IC chip embedded in the finished cards. The plastic card includes: a coupling hole 11 formed on the surface of the plastic card 10; and a rivet 20 made of noble metal and inserted into the coupling hole 11, the rivet 20 having a head 20a formed and fixed to the coupling hole 11 by pressing the lower portion thereof in a state where the rivet 20 is inserted into the coupling hole 11 and a jewel 21 firmly fixed on the upper portion of the rivet 20.

### TECHNICAL FIELD

The present invention relates to a plastic card for a special member, and more particularly, to a plastic card for a special member, which is decorated with noble metals and jewels and has a beautiful three-dimensional pattern formed on the surface thereof, thereby providing a user with refinement.

### BACKGROUND ART

In general, a plastic card can be used instead of cash like a credit card, a cash card or a transportation card or utilized as a consultation card or a membership card. The plastic card is a sort of plastic money issued to a specific member for verifying a grace period for payment of product prices or service prices, and is widely used at present. Now, there are a number of plastic cards of various kinds, which are differentiated according to a customer's credit level.

A gold card, which is provided to a VIP customer who is a person of high credit level, is widely used. Recently, a platinum card, which means a white gold card, is higher in level than the gold card and is developed to satisfy members with differentiated services and values, is used.

However, the gold card has a differentiated outward appearance since it is coated with gold color to provide a sense of refinement, but the platinum card is less in refinement of the outward appearance than the gold card since the platinum card is coated with silver color for merely expressing the texture of white gold. Therefore, there is an urgent need for a platinum card, which is more beautiful in outward appearance and higher in refinement than the gold card.

### DISCLOSURE OF INVENTION

Technical Problem

Accordingly, the present invention has been made to solve the above problem occurring in the prior art, and it is an object of the present invention to provide a plastic card for a special member, which is decorated with noble metals and jewels and has a beautiful three-dimensional pattern formed on the surface thereof, thereby providing a user with refinement.

Technical Solution

To achieve the above object, the present invention provides a plastic card for special member for providing a financial transaction function, which is manufactured by performing the steps of thermally bonding thin synthetic resin sheet layers to form a card sheet, die-cutting the card sheet into a number of rectangular finished cards, and attaching a magnetic tape for recording information on the finished cards or having an IC chip embedded in the finished cards, including: a coupling hole formed on the surface of the plastic card; and a rivet made of noble metal and inserted into the coupling hole, the rivet having a head formed and fixed to the coupling hole by pressing the lower portion thereof in a state where the rivet is inserted into the coupling hole and a jewel firmly fixed on the upper portion of the rivet.

Advantageous Effects

According to the present invention, the rivet 20 of noble metal is coupled with the coupling hole 11 formed at the center of the plastic card 10 and the jewel 21 such as diamond is fixed on the rivet 20 so that the plastic card 10 decorated with the gorgeous ornaments such as jewels and noble metal can show the beautiful outward appearance and provide the greatest refinement. In addition, the present invention can realize the plastic card 10 of higher grade well matched to the special member since it provides a sense of unique texture through the specially designed three-dimensional pattern 12 of the concave and convex shape and the beautiful outward appearance. Therefore, the plastic card for special member according to the present invention can enhance the international competitiveness thereof.

### BRIEF DESCRIPTION OF THE DRAWINGS

FIG. 1 is a perspective view showing a plastic card according to the present invention;

FIG. 2 is an exploded perspective view of the plastic card according to the present invention; and

FIG. 3 is a sectional view of the plastic card according to the present invention.

### BEST MODE FOR CARRYING OUT THE INVENTION

Reference will now be made in detail to the preferred embodiments of the present invention, examples of which are illustrated in the accompanying drawings.

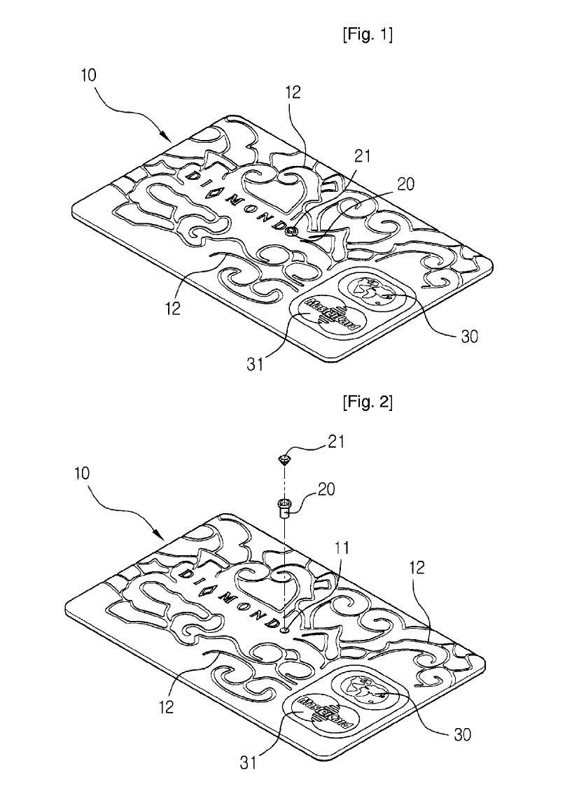

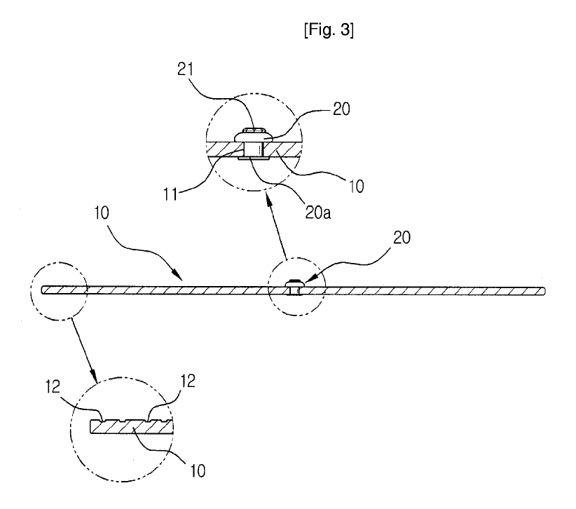

As shown in FIGS. 1 to 3, a plastic card 10 according to the present invention is manufactured by performing the steps of thermally bonding five to seven thin synthetic resin sheet layers so as to form a card sheet with a thickness of about 0.8 mm, and die-cutting the card sheet into a number of rectangular finished cards.

For the purpose of a user's financial transactions, a magnetic tape for recording information is attached on the plastic card or an IC chip is embedded in the plastic card.

Of course, such a plastic card 10 as constructed above has been widely known. However, the most important characteristic of the present invention is in the fact that the plastic card 10 is decorated with noble metals and jewels so as to provide the user with refinement to fabricate a card for a special member of the present invention.

The plastic card 10 includes a coupling hole 11 formed at the center thereof, and a rivet 20 made of noble metal and inserted into the coupling hole 11.

The rivet 20 is made of noble metal such as gold, platinum or silver, and is in the shape of a hollow tube.

In a state where the rivet 20 is inserted into the coupling hole 11, when the lower portion of the rivet 20 is pressed, a head 20a is formed, and hence, the rivet 20 inserted into the coupling hole 11 can be firmly fixed to the coupling hole 11.

Furthermore, a jewel 21 is firmly fixed to the upper portion of the rivet 20 of the tubular shape.

The jewel 21 is fastened integrally with the rivet 20 fused when the upper portion of the rivet 20 is heated in a state where the jewel 21 is fit on the upper portion of the rivet 20, which is the noble metal tube. The rivet 20 on which the jewel 21 is firmly fixed is inserted and fixed into the coupling hole 11 formed on the plastic card 10.

The jewel 21 may be one of expensive jewels such as diamond, emerald, sapphire, ruby, jade, and so on, but according to circumstances, may be an artificial jewel of inexpensive price, such as synthetic jewel. Therefore, the present invention is not limited to the expensive kinds of jewels.

However, to show a special quality of the platinum card, it is preferable to enhance the refinement of the card by decorating it with the rivet 20 made of platinum and the jewel 21 made of diamond.

Mode for the Invention

The present invention can provide the plastic card of higher grade well-matched to the special member's nobility, since the rivet 20 of noble metal is coupled with the coupling hole 11 formed at the center of the plastic card 10 and the jewel 21 such as diamond is fixed on the rivet 20 so that the plastic card 10 decorated with the gorgeous ornaments such as jewels and noble metal can show the beautiful outward appearance and provide the greatest refinement.

Meanwhile, the plastic card 10 has a stereoscopic pattern 12 of a concave and convex shape specially designed and formed on the surface thereof. The stereoscopic pattern 12 is formed by an embossing process in such a way as to thermally compress a concave and convex pattern formed on an upper mold to which a heater is mounted when the synthetic resin sheets are piled up and bonded by heat.

Therefore, the present invention can realize the plastic card 10 of higher grade well matched to the special member since it provides a sense of unique texture through the specially designed three-dimensional pattern 12 of the concave and convex shape and the beautiful outward appearance.

In the drawings, the unexplained reference numeral 30 designates a hologram attached on the surface of the plastic card 10, and 31 designates a print indicating an emblem of a company.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above, the rivet 20 of noble metal is coupled with the coupling hole 11 formed at the center of the plastic card 10 and the jewel 21 such as diamond is fixed on the rivet 20 so that the plastic card 10 decorated with the gorgeous ornaments such as jewels and noble metal can show the beautiful outward appearance and provide the greatest refinement. In addition, the present invention can realize the plastic card 10 of higher grade well matched to the special member since it provides a sense of unique texture through the specially designed three-dimensional pattern 12 of the concave and convex shape and the beautiful outward appearance. Therefore, the plastic card for special member according to the present invention can enhance the international competitiveness thereof.

1. A plastic card for special member for providing a financial transaction function, which is manufactured by performing the steps of thermally bonding thin synthetic resin sheet layers to form a card sheet, die-cutting the card sheet into a number of rectangular finished cards, and attaching a magnetic tape for recording information on the finished cards or having an IC chip embedded in the finished cards, comprising:
a coupling hole 11 formed on the surface of the plastic card 10; and a rivet 20 made of noble metal and inserted into the coupling hole 11, the rivet 20 having a head 20a formed and fixed to the coupling hole 11 by pressing the lower portion thereof in a state where the rivet 20 is inserted into the coupling hole 11 and a jewel 21 firmly fixed on the upper portion of the rivet 20.

2. A plastic card for special member according to claim 1, wherein the rivet 20 is made of any one of noble metal materials such as gold, platinum, silver and the likes, and the jewel 21 is any one selected from the group consisting of diamond, emerald, sapphire, ruby, jade, synthetic jewel and artificial jewel.

3. A plastic card for special member according to claim 1, wherein a specially designed three-dimensional pattern 12 of concave and convex shape is formed on the surface of the plastic card 10 by heating and compressing a mold which has a concave and convex part.
